(19) United States
(12) Patent Application Publication
(10) Pub. No.: US 2004/0101171 A1
(43) Pub. Date: May 27, 2004

(54) Imaging system with guide for accurate fingerprint recognition

(75) Inventors: Fred P. Lane, Highland Village, TX (US); David Gill, Dallas, TX (US)

Correspondence Address: Lisa K. Jorgenson, Esq., STMicroelectronics, Inc., 1310 Electronics Drive, Carrollton, TX, 75006, US

(73) Assignee: STMicroelectronics, Inc., Carrollton, TX

(21) Appl. No.: 10/335,586

(22) Filed: Dec. 31, 2002

Related U.S. Application Data
(60) Provisional application No. 60/429,194, filed on Nov. 26, 2002.

(51) Int. Cl. G06K 9/00

(52) U.S. Cl. 382/124

(57) ABSTRACT

A finger imaging system for receiving and holding a finger of a person being fingerprinted by an automated fingerprint reader. The system includes a finger imaging device having a finger receiving portion and a finger positioning portion, together forming a recess of reducing dimension such that a subject finger forceably inserted into it is held in a stable position. The finger positioning portion may have a flexible or resilient surface contacting the finger to enhance the stabilizing effect. The flexible surface may be inflated to increase the retaining pressure.

### PRIORITY CLAIM TO PROVISIONAL PATENT APPLICATION

This patent application claims priority to U.S. Provisional Patent Application Serial No. 60/429,194 filed on Nov. 26, 2002.

### CROSS-REFERENCE TO RELATED PATENT APPLICATION

The invention disclosed in the present patent application is related to the invention disclosed in U.S. patent application Ser. No. [Attorney Docket No. STMI01-01115], filed concurrently herewith, entitled “IMAGING SYSTEM WITH LOCATOR BAR FOR ACCURATE FINGERPRINT RECOGNITION” which is commonly owned by the assignee of the present invention. The disclosure of this related United States patent application is incorporated herein by reference for all purposes as if fully set forth herein.

### TECHNICAL FIELD OF THE INVENTION

The present invention is directed generally to automated fingerprint recognition, and more specifically, to a device for improving the accuracy and legitimacy of automated fingerprint readers by providing a secure, stable platform for the subject finger during the reading process.

### BACKGROUND OF THE INVENTION

Fingerprints provide a unique way of determining an individual's identity. Even in the absence of identifying scars or markings, the natural undulations in the skin on the tip of one's finger form a pattern that for most purposes may be considered to be unique. Many years ago it was discovered that a close examination of a person's fingerprints could be used to determine if the person was in fact the person he or she claimed to be (or was thought to be). Not only that, it was also discovered that a person touching an object with the fingertips often leaves behind residue that forms a fingerprint pattern. The presence of this residue might be highlighted with the use of a dusting powder so that the pattern becomes clearly visible, and the person or persons that recently touched the object might thereby be identified.

A familiar use of this technique may be found in many detective novels, where it may be used to catch a thief or other villain. Of course, it is often just as useful for such purposes in real life as well. Particularly where the perpetrator of a crime does not employ sufficient forethought to make sure that no fingerprints are left behind, the presence of the perpetrator at a crime scene may be quickly established through the use of identifying fingerprints. In some cases the absence of such evidence may also serve to exonerate the innocent.

Fingerprint identification may also be employed outside of the crime-scene context. In some instances, a person may wish to be uniquely identifiable in some way. For example, a person having a bank account may carry a photo identification (ID) card that also bears a likeness of their fingerprint. The ID card may then be matched at any time with the “print” of a person presenting it, thereby providing an additional assurance that they are in fact the account holder. In this manner access to account funds by imposters is discouraged or thwarted completely. The bona fide fingerprint may be reproduced on a person's driver's license, or even on a personal check itself, in order to avoid the need to carry a separate ID card. In another example, a business that regularly accepts personal checks may simply require that a patron paying in this manner produce a fingerprint that can be retained and associated with the check in the future if a question arises as to whether it was actually the account holder that paid with it.

In similar fashion, the identity of employees, couriers, or security personnel may be more confidently verified using fingerprint comparison. For any such identification system to work effectively, of course, a known person's fingerprint must be obtained and kept available so that the necessary comparison may be made. As mentioned above, one way to do this is using a card on which the print is reproduced, perhaps accompanied by the person's photograph and signature. To the extent such a card can be produced, however, it could also be forged, a fact detracting somewhat from the veracity of the verification process. To overcome this disadvantage, a file containing the fingerprints of many people may be maintained, and organized so that the prints of a given person may easily be retrieved whenever it becomes necessary to confirm their identity.

Fingerprints may be reproduced by applying ink to one of the subject's fingertips and then pressing it onto a card or sheet of paper. (Other, similar media may be used as well.) With the proper amount of ink and pressure, fairly accurate copies may be obtained. A human attendant is often present at the fingerprinting process in order to assist the subject in performing the operation properly and to verify that an accurate reproduction has been made. The process is often repeated for all of the fingers, producing a “set” of prints. A note is made of the subject's identity, and the sheet or card bearing the set is stored until needed for future reference.

With a great many people to identify, however, the organization of so many records becomes cumbersome. In addition, the opportunity for human error in the comparison process becomes greater. In many situations, cost of maintaining a human presence to retrieve and compare the fingerprints is prohibitive. All of these problems have been addressed in recent times through the use of automated fingerprint analysis.

For automated (electronic) fingerprint systems to come into being, several hurdles had to be overcome. Initially, the fingerprint image itself had to be digitally represented in order to store it in a database. Various techniques for storing graphic images have been developed to make such databases feasible. With such techniques came also the ability to draw or print out a reproduction of the fingerprint when necessary. Further advances in technology permitted the comparison itself to be automated, and generally with more accurate results than if a human were making the same comparison. And presented with a fingerprint, the computer performing the comparison can rapidly search the database (perhaps containing thousands of records) for matches to determine if the print matches any one of them.

The electronically stored fingerprint records may be captured by machine as well. FIG. 1 is a simplified sketch illustrating the typically essential components of a fingerprint capturing system 100 according to an embodiment of the prior art. To obtain a fingerprint, the subject places a finger 101 on the plate 105. Plate 105, for simplicity shown here in cross section, is generally made of a transparent material such as glass or plastic. Although the extent of plate 105 is not illustrated in FIG. 1, it may be of any size that will accommodate the fingers of anticipated users.

Disposed on the opposite side of plate 105 from the subject finger are illumination sources 110, which may be on continuously or may “flash” in order to temporarily illuminate the finger. Light from illumination sources 110 passes through the plate 105 to finger 101, from which some of the light is reflected back though plate 105. Light passing back through plate 105 is focused by lens 115 so that an image of the finger, and specifically a fingerprint, may be captured by image-capturing device 120. Image-capturing device 120 may be a standard charge-coupled device (CCD) or similar apparatus. The image captured by CCD 120 is read out in electronic form under the direction of controller 125, and then transmitted to be stored in a database or analyzed by a processor (not shown) that is associated with the fingerprint capturing system 100.

This simple system 100 described above is intended to obtain for storage and analysis a copy of the “fingerprint,” or pattern formed by small skin undulations on the anterior side 102 of finger 101. FIG. 2 is a front view of finger 101 where anterior side 102 may be seen to exhibit such a pattern. As mentioned above, this pattern is typically unique to the individual possessing it and can therefore be used for identification. The broken line in FIG. 2 delineates the “fingerprint” area itself.

Note that although not shown in FIG. 1, the fingerprint pattern typically extends somewhat around the sides 104 and the fingertip 103. In order to capture more of the pattern, the finger may be rolled from side to side. This operation is somewhat easier where an inked print is being produced on a fingerprint card than when using an automated reader such as is illustrated in FIG. 1 and described above. To obtain a “rolled” print, the image-capturing device 120 would have to be capable of capturing a moving image or be programmed to take multiple images. The processor would also have to be able to effectively analyze such images. More often, automated systems will be designed to capture only single “still” images of each proffered finger.

Even so, the problem of finger movement or inaccurate placement may reduce the accuracy with which an automated system such as system 100 can reproduce the fingerprint on anterior surface 102 of finger 101. If the subject's finger moves at the moment when the image is being captured, a suitable reproduction may not be obtained. Finger movement is a major cause of smudges in inked fingerprints.

An automated system minimizes the problem of finger movement because the image capture procedure is virtually instantaneous with respect to human movement. This means that it is more difficult to obtain a blurred image. However, when a blurred image is obtained it is necessary to evaluate the quality of the image and then retake the image if the image quality is unacceptable.

If a “rolled” print is desired, the finger movement problem may be exacerbated because it will require the subject to follow a specific procedure for rolling the finger to produce the desired result. In addition, there may be no attendant to assist in making sure that the procedure is executed properly and with no attempt at deception. One reason for the automated reader in the first place, after all, is to eliminate the need for an attendant.

Therefore, despite the advances that have been made in the field of automated fingerprint reading, there remains a need in the art for an improved fingerprint reader that provides a more suitable fingerprint imaging system for stabilizing a subject's finger during the fingerprinting process and providing some assurance that the fingerprint obtained is legitimate.

### SUMMARY OF THE INVENTION

To address the above-discussed deficiencies of the prior art, the present invention introduces an automated finger imaging system that is well suited for accurately capturing and processing fingerprint images for use in identification, security, and other applications. As fingerprints are unique, and tend to remain distinctive throughout the life of an individual, they may be used to verify a person's identity when, for example, advancing funds or controlling entrance to a secure facility.

A particularly useful application of the present invention is one including use of a finger image processor, possibly executing suitable pattern recognition software, that operates to identify similarities between fingerprints being scanned and those already scanned and stored in memory associated with the processor. In some of these applications, the identity-verification process will be completely automated.

An exemplary finger imaging system comprises a finger imaging device and a finger image processor. This exemplary system facilitates execution of a reliable methodology for personal identification, and is particularly useful as the basis for, or at least an integral part of, a pattern recognition security access system.

The exemplary finger imaging device comprises a finger receiving surface and a guide. The guide comprises a substantially rigid portion that directs the finger to be imaged toward the finger receiving surface as it is inserted by the subject, and preferably includes a positioning portion as well. The positioning portion is disposed on an interior surface of the substantially rigid portion for contacting the finger when it is being placed on the finger receiving surface. The positioning portion exerts increasing force to the finger as the finger is inserted and directed toward the finger receiving surface. The finger imaging device may further comprise an image-capturing device, such as a charged couple device (CCD), and a controller. The controller is operable to provide an image signal representing at least one image characteristic of a finger positioned at the finger receiving surface. The finger image processor operates to process the image signal as a function of the at least one image characteristic of the finger.

According to various advantageous embodiments of the present invention, the substantially rigid portion of the guide is made of one of a metal, a ceramic, a resin, a composite material, an organic material, and a static dissipative material.

According to a related embodiment, the positioning portion comprises a semi-flexible exterior for contacting the inserted finger. In one embodiment, the semi-flexible exterior forms a cavity, which is at least substantially filled with liquid, gas, or some suitable combination thereof. In this embodiment, the positioning portion may be a bladder, which as used herein may be defined broadly hollow or inflated sac-like structure.

According to a technologically sophisticated embodiment, the positioning portion is associated with at least one sensor for sensing a non-image characteristic of the finger being imaged. The sensor may be, for instance, associated with the controller, which is further operable to generate a non-image signal representing the sensed at least one non-image characteristic of the finger. In one implementation hereof, the finger image processor is likewise further operable to processes the non-image signal as a function of the at least one non-image characteristic thereof.

According to another advantageous embodiment, at least one sensor associated with the positioning portion is capable of sensing a non-image signal that represents pulses of blood pressure through the finger that is being imaged.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the terms “controller” and “processor” means any device, system or part thereof that controls at least one operation, such a device may be implemented in hardware, firmware or software, or some combination of at least two of the same. It should be noted that the functionality associated with any particular controller or processor may be centralized or distributed, whether locally or remotely. Definitions for certain words and phrases are provided throughout this patent document, those of ordinary skill in the art should understand that in many, if not most instances, such definitions apply to prior uses, as well as future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a simplified sketch illustrating the essential components of a fingerprint reader according to an exemplary embodiment the prior art;

FIG. 2 illustrates a front view of a fingertip bearing a fingerprint such as might be reproduced with the aid of the device of the present invention;

FIG. 3 is an isometric view of a finger imaging device according to an exemplary embodiment of the present invention;

FIG. 4 is an isometric illustration of a finger imaging device according to another exemplary embodiment of the present invention;

FIG. 5 is a partially cut away side view illustrating selected components of a finger imaging device similar to that of both FIGS. 3 and 4;

FIG. 6 is the partially cut away side view of the finger imaging device of FIG. 5 illustrating the position of a subject finger as it is being inserted for fingerprinting;

FIG. 7 is the partially cut away side view of the finger imaging device of FIG. 5 illustrating a fingertip being retained in place for accurate fingerprinting according to an exemplary embodiment of the present invention;

FIG. 8 illustrates an image capturing system utilizing a finger imaging device according to an exemplary embodiment of the present invention;

FIG. 9 illustrates a partially cut away side view of an alternate embodiment of the finger imaging device of the present invention;

FIG. 10 illustrates a first type of prior art inaccuracy that may be prevented by the present invention;

FIG. 11 illustrates a second type of prior art inaccuracy that may be prevented by the present invention; and

FIG. 12 illustrates a third type of prior art inaccuracy that may be prevented by the present invention.

### DETAILED DESCRIPTION OF THE INVENTION

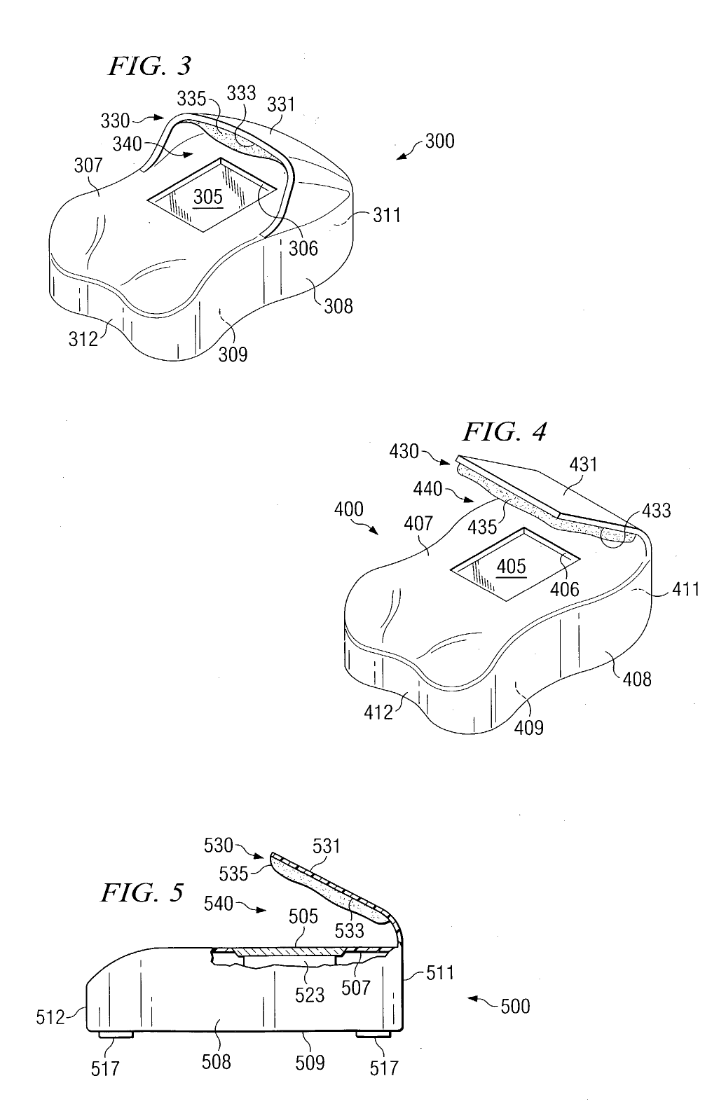

FIGS. 3 through 12, discussed below, and the various embodiments used to describe the principles of the present invention in this patent document are by way of illustration only and should not be construed in any way to limit the scope of the invention. Those skilled in the art will understand that the principles of the present invention may be implemented in any suitably configured biometric device.

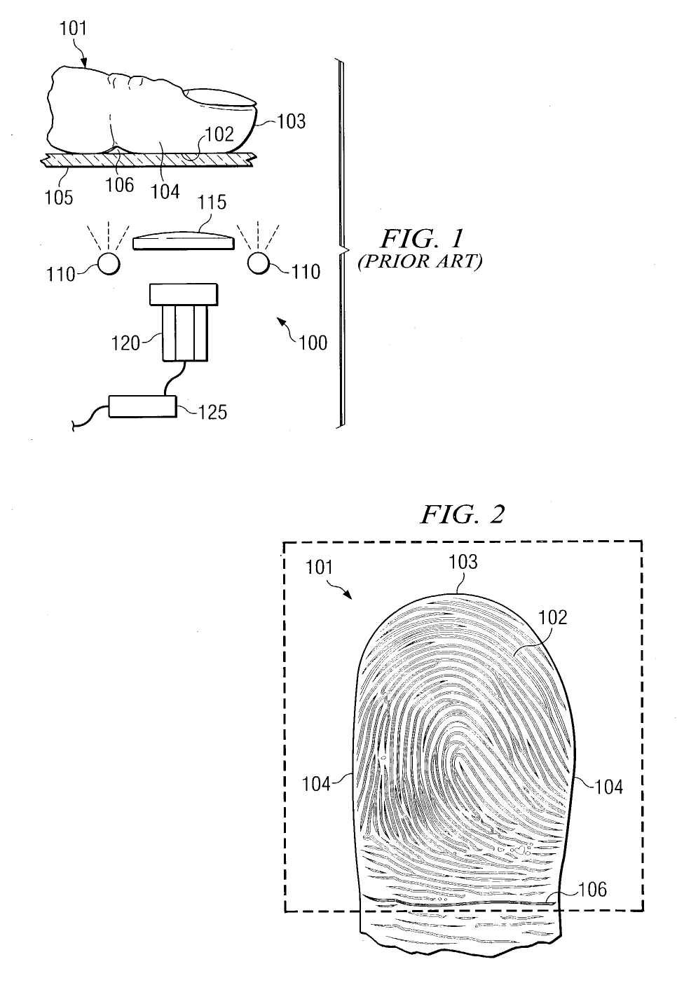

The present invention is directed toward a more accurate and consistent image capturing system for capturing the images of fingerprints, the system having a finger imaging device for guiding a subject's finger into position, for holding it stable during the image capturing process, and sometimes for manipulating it into a desired motion. The various components of the finger imaging device will now be described in more detail. Note that where there is a similarity with the standard imaging system of the prior art (as illustrated in FIG. 1), or between the different embodiments, analogous though not identical reference numbers will be used. In this regard, note that the repetition (or absence) of certain features from one exemplary embodiment to another does not necessarily indicate that they are required (or prohibited) features. The required features, of course, are specifically set forth within the claims.

FIG. 3 is an isometric illustration of a finger imaging device 300 according to an advantageous embodiment of the present invention. Finger imaging device 300 includes a transparent plate 305 mounted within an imaging window 306 where the subject's finger will be placed in order to capture an image of the fingerprint. Window 306 is formed in the finger receiving surface 307 of finger imaging device 300. Finger receiving surface 307, along with bottom 309, sides 308, fore end 311, and back end 312 form an enclosure for the internal components (not shown in FIG. 3) of finger imaging device 300. No specific internal components are required by the present invention, but they will typically include an illumination source and CCD, along with the controller, circuitry, and other components necessary to transmit the captured image. For simplicity, these internal components, which form part of the invention only where explicitly recited, are otherwise referred to only generally.

In the embodiment of FIG. 3, guide 330 is integrally formed with the sides 308 and fore end 311 of finger imaging device 300. In an alternate embodiment (not shown), the guide may be a separately formed component that is attached by an adhesive, fasteners, or some other suitable means. The guide 330, which forms part of the apparatus for stabilizing the subject finger, creates, along with finger receiving surface 307, a recess 340 for receiving the finger to be fingerprinted. In a preferred embodiment, therefore, the recess 340 so formed will approximate the size and shape of the fingertips expected to be received.

Guide 330 comprises a substantially rigid portion 331 that directs finger 101 toward finger receiving surface 307. Substantially rigid portion 331 of guide 330 may comprise a metal, a ceramic, a resin, a composite material, an organic material, or a static dissipative material. A static dissipative material may be electrically grounded so that the static dissipative material will conduct any static electricity that is present on finger 101 into guide 330 (and not into the sensor) of finger imaging device 300.

Guide 330 also comprises a positioning portion 335 for contacting finger 101 and positioning finger 101 between the substantially rigid portion 331 of guide 330 and finger receiving surface 307. In the embodiment shown in FIG. 3, the positioning portion of guide 330 comprises bladder 335. Bladder 335 is disposed on the interior surface 333 of guide 330. As used herein, the term bladder broadly refers to any hollow, flexible sac-like structure that deforms as a finger is pressed against it when received in the recess 340. The bladder is preferably attached to the interior surface 333, covering a substantial portion of its area. Bladder 335 is filled with air, a liquid fluid, or some other suitable material or combination of materials. In one embodiment, the bladder is of a fixed volume, that is, although it is made of a flexible material and deforms to conform to the shape of the received finger, the total volume of material enclosed by the bladder remains constant. When this is the case, as the subject's finger is received into the recess 340 the pressure upon it from the bladder increases, tending to hold it in a stable relationship as an image of the fingerprint is being captured.

In another embodiment, the volume of the bladder 335 is variable, meaning that the substance occupying its interior may be moved in and out in a controlled fashion as desired. In this way, for example, the bladder pressure may be increased when the subject finger has been presented. The increased bladder pressure stabilizes the finger so that the fingerprint may be accurately captured, although presumably the pressure will not be so great as to cause discomfort for the subject. In this embodiment, an emergency pressure release mechanism (not shown) may be provided for safety purposes.

Where a variable pressure bladder is used, a controller of the finger imaging device 300 may control a pump or hydraulic system (not shown) that is operable to increase the fluid pressure in the bladder when it is appropriate to do so, as determined by individual design considerations. For example, a mechanical or optical sensor may signal that a subject finger has been placed on the finger receiving surface 307 and the pressure should be increased in order to stabilize it. Alternately, the subject themselves may actuate a switch or button indicating readiness, and at that time the pressure could be increased before the image is captured.

In yet another embodiment, the bladder 335 includes a number of individually controllable cells that may be sequentially inflated and deflated to induce a rolling motion in the subject finger so that a broader area of the fingerprint may be captured. A mechanical roller (not shown) may be installed inside the bladder 335 to the same purpose, either by itself or in cooperation with selective cell inflation. In addition, note that the bladder may be partially formed by interior surface 333 of guide 330, to which the flexible portion of bladder 335 is securely attached. Note that interior surface 333 may not itself be flexible, but as should be apparent need not be for the bladder 335 to perform its intended function.

Note that in lieu of the bladder a solid resilient member may be used, such as a piece of foam rubber. This simple alternative may provide easier construction, and stabilize the subject finger suitably for a particular application. Note also that the guide of the present invention may be used together with a structure that extends from the finger receiving surface, as described in detail in U.S. patent application Ser. No. [Attorney Docket No. STMI-0101115], referred to above and previously incorporated herein by reference. In such a case (not illustrated in FIG. 3) the guide 330 may cooperate with a locator bar or similar structure to stabilize the finger in its proper position or assist its desirable manipulation.

The use of guide 330 helps ensure both the integrity and the legitimacy of the captured fingerprint. Regarding the former, guide 330 helps to maintain the position of the finger, so that a misidentification does not occur simply because the subject has carelessly moved their finger while the fingerprint was being taken. The need to “legitimate” the print requires a brief explanation.

Although fingerprints are unique, they may be artificially created and reproduced. If a fingerprint is, for example, copied onto a piece of rubber or plastic stock, the resulting object may be used to “trick” the automated system into believing the actual subject has presented a finger for imaging. If a false identify match is produced, the wrong person may be admitted to a secure area where they are not allowed, or given access to funds that are not their own. Moreover, the “counterfeit” fingerprint may be copied surreptitiously from an object touched by the actual fingerprint bearer, meaning that obtaining the real print for copying may not be difficult.

In one embodiment, guide 330 may help avoid such deception including one or more sensors (not shown) for sensing non-image information from the subject finger. This non-image information may be, for example, the temperature or dampness of the offered finger, or the pulse rate or blood pressure of the subject. (Where a variable volume bladder is used, the systolic and diastolic blood pressure readings may even be obtained.) Although these characteristics may vary to some degree even in the same individual, they may be difficult to accurately reproduce within a reasonably expected range by using a rubber or plastic object that merely bears the subject's fingerprint. The non-image information collected by the sensors in, for example, bladder 335 may substantially frustrate any attempt to trick the imaging system. While a variety of these non-image characteristics may also be artificially produced, the equipment required to do so reliably might be too conspicuous for reliable use. A video camera in the general area might be sufficient to discourage an attempt to do so. Note that while guide 330 is a preferable location for the non-image information sensors, they may also be placed in other positions as well, for example on the finger receiving surface 307 itself.

FIG. 4 is an isometric illustration of a finger imaging device 400 according to another exemplary embodiment of the present invention. Note again that its features corresponding to features of the embodiment of FIG. 3 are analogously but not identically numbered. In the embodiment of FIG. 4, guide 430 is integrally formed with fore end 411 of finger imaging device 400 but not with sides 408. This may be preferable in some applications, for example where an external video camera for capturing an image of the subject could also be used to “witness” the placement of the subject's finger into the finger imaging device 400. As mentioned above, this is one way that deceit may be discouraged or detected. Note that the guide 430 does not have to be connected with or attached to the finger receiving surface 407 or the fore end 411 at all, so long as some means is provided to hold it in the proper relationship to these features.

FIG. 5 is a partially cut away side view illustrating selected components of a finger imaging device 500, which is similar to that shown in both FIGS. 3 and 4. In this view, internal components 523 are generally illustrated, mounted below glass plate 505. Also visible are pedestals 517 which may be used to support the finger imaging device 500, or alternately to anchor it to the surface on which it is disposed.

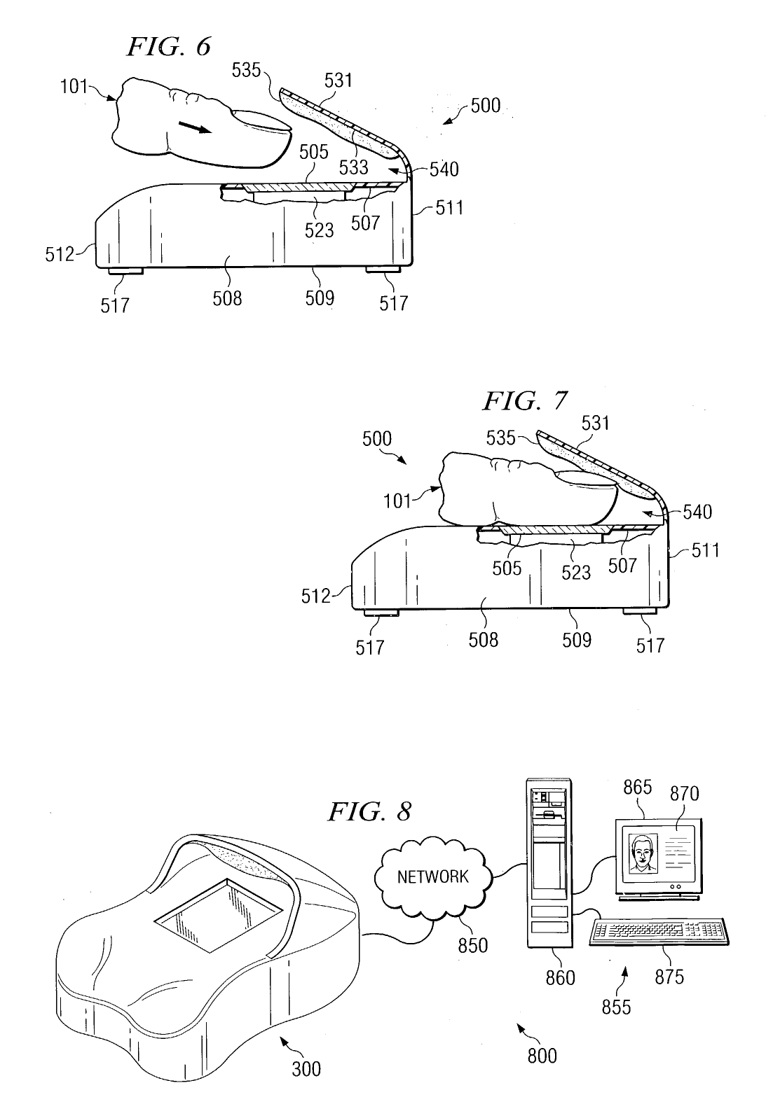

FIG. 6 is a partially cut away side view of finger imaging device 500 of FIG. 5 illustrating the position of a subject finger at the point of being inserted for fingerprinting. As indicated by an arrow shown on finger 101, finger 101 is inserted into recess 540 in the direction of the fore end 511 of finger imaging device 500. At this point the bladder 535 is simply in its relaxed, or undeformed configuration.

FIG. 7 is a partially cut away side view of the finger imaging device 500 of FIG. 5, illustrating a fingertip being restrained in place for accurate fingerprinting according to an exemplary embodiment of the present invention. When the subject finger 101 is fully inserted, it is gently forced against the plate 305 by the pressure exerted by deformed bladder 530 (trying to return its undeformed shape) or by the pressure of the fluid inside it. Preferably, of course, the subject finger is held firmly in the proper position but not squeezed to the discomfort of the subject. A separate sensor (not shown) may be used to indicate that the finger 101 is now in the proper position, or the controller may determine this simply from the image it received from the image-capturing device.

FIG. 8 illustrates an image capturing system 800 using a finger imaging device 300 according to an exemplary embodiment of the present invention. In the embodiment of FIG. 8, a finger imaging device 300 is in communication with a communication network 850. The network 850 may, for example, be a small network such as a local area network (LAN), or may be the Internet, or may be a large virtual private network (VPN). Although a wired connection to the network 850 is shown in FIG. 8, the connection could also be wireless, for example using a radio frequency (RF) or infrared (IR) communication system. Also connected to the network 850 is a computing entity 855, which in this embodiment includes a personal computer (PC) 860, a display monitor 865, and a keyboard 875. The PC 860 contains both data storage media and a processor (not shown).

The image captured by finger imaging device 300 is transmitted to computing entity 855 where it is analyzed or stored according to the design of the system. For example, where the purpose of the system is to verify identity, the subject may (prior to offering a finger for fingerprinting) enter a personal identification number (PIN) on a keypad (not shown) located at or near the finger imaging device 300. Or the necessary input devices may be provided for the subject to orally pronounce the PIN or simply give their name.

When the fingerprint image is captured and transmitted to the computing entity 855, it can be compared with a reference fingerprint that has been stored there. If the fingerprints match, then the subject's identity has been confirmed. Alternately, in another application the subject's fingerprint may simply be captured and transmitted to the computing entity 855, which then searches a database for a fingerprint that matches the one it has just received. When a match is found, information regarding the person associated with the stored fingerprint may be displayed on the screen 870 of display monitor 865. If present, a security officer may use the keyboard to direct the system to open a door, or may request additional information from the subject. While in this application the need for a human attendant is re-introduced, a single security officer may be able, though network 850, to monitor input from dozens of finger imaging devices like finger imaging device 300. Of course, more than one computing entity may be used as well. In another embodiment (not shown) the finger imaging device 300 may simply be connected directly to one or more computing entities. In fact, the computing entity may even be physically co-located in the same cabinet or case as the finger imaging device 300.

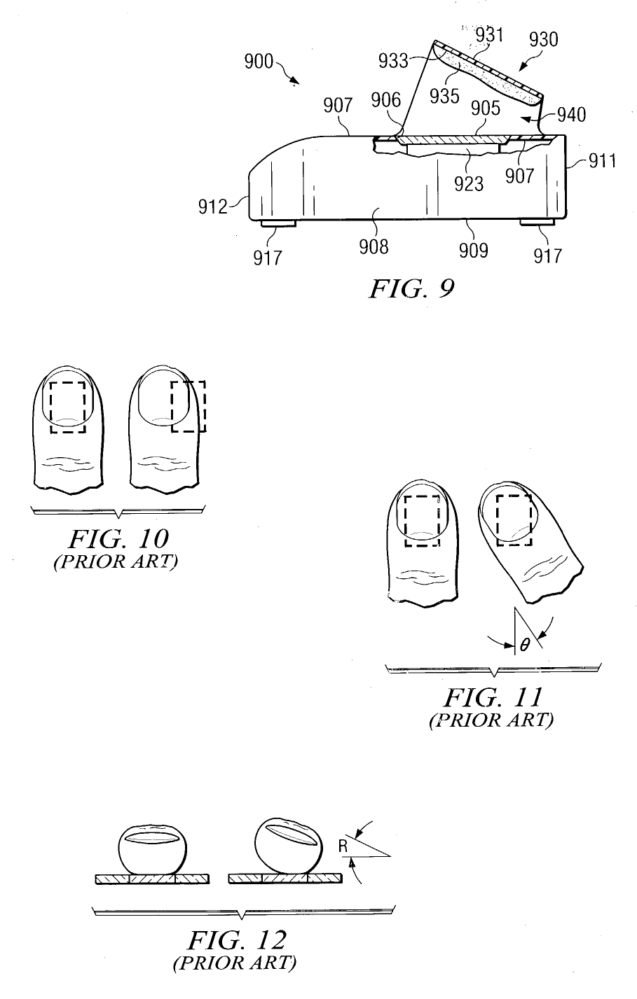

FIG. 9 is a partially cut away side view of an alternate advantageous embodiment of a finger imaging device 900 of the invention. Finger imaging device 900 comprises transparent plate 905 mounted within an imaging window 906 where the subject's finger will be placed in order to capture an image of the fingerprint. Window 906 is formed in the finger receiving surface 907 of finger imaging device 900. Finger receiving surface 907, along with bottom 909, sides 908, fore end 911, and back end 912 form an enclosure for the internal components (not shown in FIG. 9) of finger imaging device 900.

In the embodiment shown in FIG. 9, guide 930 is integrally formed with the sides 908 of finger imaging device 900. In an alternate embodiment (not shown), guide 930 may be a separately formed component that is attached by an adhesive, fasteners, or some other suitable means. The guide 930, which forms part of the apparatus for stabilizing the subject finger, creates, along with finger receiving surface 907, a recess 940 for receiving a finger to be fingerprinted. In this advantageous embodiment, the forward end of guide 930 is open. Therefore, recess 940 accommodates the size and shape and length of the fingertips expected to be received. Specifically, the openness of guide 930 accommodates fingers (and fingernails) of different lengths.

Guide 930 comprises a substantially rigid-portion 931 that directs finger 101 toward finger receiving surface 907. Substantially rigid portion 931 of guide 930 may comprise a metal, a ceramic, a resin, a composite material, an organic material, or a static dissipative material. A static dissipative material may be electrically grounded so that the static dissipative material will conduct any static electricity that is present on finger 101 into guide 930 (and not into the sensor) of finger imaging device 900.

Guide 930 also comprises a positioning portion 935 for contacting finger 101 and positioning finger 101 between the substantially rigid portion 931 of guide 930 and finger receiving surface 907. In the embodiment shown in FIG. 9, the positioning portion of guide 930 comprises bladder 935. Finger imaging device 900 operates in the same manner that has been previously described for finger imaging devices 300, 400 and 500.

The finger imaging device of the present invention positions finger 101 in a stable placement position for the fingerprint measuring process. The present invention restricts the placement position of finger 101 in order to prevent certain types of inaccuracies that may occur when finger 101 is placed into position for fingerprint measuring.

FIG. 10 illustrates a first type of prior art inaccuracy that may be prevented by the present invention. FIG. 10 illustrates how finger 101 may be shifted or translated. The shift may be lateral in either the horizontal direction (X-axis) or in the vertical direction (Y-axis) or in both the horizontal direction and the vertical direction simultaneously. The present invention insures that finger 101 is placed in the same location each time that finger 101 is measured.

FIG. 11 illustrates a second type of prior art inaccuracy that may be prevented by the present invention. FIG. 11 illustrates how finger 101 may be laterally rotated. The lateral rotation may be in either a right rotation direction (positive angle θ) or in a left rotation direction (negative angle θ). The present invention insures that finger 101 is placed in the same lateral angular location each time that finger 101 is measured.

FIG. 12 illustrates a third type of prior art inaccuracy that may be prevented by the present invention. FIG. 12 illustrates how finger 101 may be vertically rotated. The vertical rotation may be in either a right rotation direction (positive angle R) or in a left rotation direction (negative angle R). The present invention insures that finger 101 is placed in the same vertical angular location each time that finger 101 is measured.

In addition to preventing the occurrence of the prior art inaccuracies described above, the present invention also provides other advantages. A first additional advantage is that the guide protects the sensor. This feature is especially valuable in applications where the sensor is unattended or subject to abuse. People may drop pens, keys, or other types of damaging objects on an exposed sensor of a finger imaging device. The guide of the present invention protects the sensor from cumulative damage and abrasion.

A second additional advantage is that there is a consistent placement of the same pattern area in the capture window. Semiconductor sensors are cheaper than optical sensors because semiconductor sensors do not require mechanical elements to set up a lens to focus a picture. This function is inherent in a manufactured semiconductor sensor. A semiconductor sensor may be mounted for use with minimal mechanical support.

The cost of the sensor is then proportional to the size of the sensor and the manufacturing cost per unit area. The smaller the sensor is, the less expensive the sensor is. However, the sensor needs to consistently capture the same pattern area.

The guidelines of the Federal Bureau of Investigation specify that eight (8) to twelve (12) minutiae points are need to constitute a legal fingerprint match. A legal fingerprint match can therefore be obtained in as little as one square centimeter (1 cm²) of pattern area. The typical capture area of fingertip is approximately six square centimeters (6 cm²). Therefore, if one has an apparatus that is capable of consistently placing the same pattern area of a finger on the sensor, the size of the sensor required (and its cost) can be minimized. This approach only works if the same area can be read consistently. The present invention provides an apparatus and method for consistently placing a same pattern area of a finger on a fingerprint sensor. If a large size sensor is used with the present invention, then the present invention increases the accuracy of the sensor.

In general, the present invention limits the angle of approach of finger 101 in terms of the X and Y components described in FIG. 10, and in terms of the angle θ described in FIG. 11, and in terms of the angle R described in FIG. 12. The present invention limits the angle of approach of finger 101 in an ergonomically suitable way. That is, it is not necessary for the subject to contort his or her hand or finger in an unnatural way. The subject simply places his or her finger into the guide and the guide naturally places the finger into the appropriate position.

Although the present invention has been described in detail, those skilled in the art should understand that they could make various changes, substitutions and alterations herein without departing from the spirit and scope of the invention in its broadest form.

What is claimed is:

1. A guide for use with a finger imaging device having a finger receiving surface, said guide comprising (i) a substantially rigid portion that directs a finger to be imaged toward said finger receiving surface, and (ii) a positioning portion for contacting said finger, said positioning portion disposed between said substantially rigid portion and said finger receiving surface, said positioning portion exerting increasing force to said finger as said finger is directed toward said finger receiving surface by said guide.

2. The guide as set forth in claim 1 wherein said substantially rigid portion is made of one of: a metal, a ceramic, a resin, a composite material, an organic material, and a static dissipative material.

3. The guide as set forth in claim 1 wherein said positioning portion comprises a semi-flexible exterior.

4. The guide as set forth in claim 3 wherein said semi-flexible exterior forms a cavity.

5. The guide as set forth in claim 4 wherein said cavity is at least substantially filled with one of a liquid and a gas.

6. The guide as set forth in claim 1 wherein said positioning portion is a bladder.

7. The guide as set forth in claim 1 wherein said positioning portion is associated with a sensor.

8. A finger imaging device comprising:
A finger receiving surface;
a controller that provides an image signal representing at least one image characteristic of a finger positioned at said finger receiving surface; and
a guide comprising:
a substantially rigid portion that directs said finger to be imaged toward said finger receiving surface, and
a positioning portion for contact with said finger between said substantially rigid portion and said finger receiving surface, said positioning portion exerting increasing force to said finger as said finger is directed toward said finger receiving surface.

9. The finger imaging device as set forth in claim 8 wherein said substantially rigid portion is made of one of: a metal, a ceramic, a resin, a composite material, an organic material, and a static dissipative material.

10. The finger imaging device as set forth in claim 8 wherein said positioning portion comprises a semi-flexible exterior.

11. The finger imaging device as set forth in claim 10 wherein said semi-flexible exterior forms a cavity.

12. The finger imaging device as set forth in claim 11 wherein said cavity is at least substantially filled with one of a liquid and a gas.

13. The finger imaging device as set forth in claim 8 wherein said positioning portion is a bladder.

14. The finger imaging device as set forth in claim 8, further comprising a sensor for sensing at least one non-image characteristic of the finger.

15. The finger imaging device as set forth in claim 14 wherein said sensor is associated with said controller, said controller further operable to generate a non-image signal representing at said least one non-image characteristic of said finger.

16. A finger imaging system comprising:
a finger imaging device comprising:
a finger receiving surface;
a controller that provides an image signal representing at least one image characteristic of a finger positioned at said finger receiving surface; and
a guide comprising:
a substantially rigid portion that directs said finger to be imaged toward said finger receiving surface, and
a positioning portion for contact with said finger between said substantially rigid portion and said finger receiving surface, said positioning portion exerting increasing force to said finger as said finger is directed toward said finger receiving surface; and
a finger image processor that processes said image signal as a function of said at least one image characteristic of said finger.

17. The finger imaging system as set forth in claim 16 wherein said substantially rigid portion is made of one of: a metal, a ceramic, a resin, a composite material, an organic material, and a static dissipative material.

18. The finger imaging system as set forth in claim 16 wherein said positioning portion comprises a semi-flexible exterior.

19. The finger imaging system as set forth in claim 18 wherein said semi-flexible exterior forms a cavity.

20. The finger imaging system as set forth in claim 19 wherein said cavity is at least substantially filled with one of a liquid and a gas.

21. The finger imaging system as set forth in claim 16 wherein said positioning portion is a bladder.

22. The finger imaging system as set forth in claim 16 wherein said positioning portion associated with a sensor.

23. The finger imaging system as set forth in claim 22 wherein said sensor is associated with said controller, said controller further operable to generate a non-image signal representing at least one non-image characteristic of said finger.

24. The finger imaging system as set forth in claim 23 wherein said finger image processor is further operable to process said non-image signal as a function of said at least one non-image characteristic of said finger.
